(19) United States
(12) Patent Application Publication
(10) Pub. No.: US 2006/0168564 A1
(43) Pub. Date: Jul. 27, 2006

(54) Integrated chaining process for continuous software integration and validation

(76) Inventors: Weijia Zhang, Round Rock, TX (US); Michael E. Brown, Pflugerville, TX (US); Kevin W. Deike, Round Rock, TX (US); Charles T. Perusse JR., Pflugerville, TX (US)

Correspondence Address: HAMILTON & TERRILE, LLP, P.O. BOX 203518, AUSTIN, TX, 78720, US

(21) Appl. No.: 11/044,091

(22) Filed: Jan. 27, 2005

(51) Int. Cl. G06F 9/44

(52) U.S. Cl. 717/121

(57) ABSTRACT

A method and apparatus for automating the installation of a plurality of operating system and device management software combinations, with their respective and related configuration data, onto a plurality of information management system platform hardware. The present invention also provides for the automated and systemic validation of proper interoperability between all installed software components. All related details of the integration, installation and validation processes are automatically recorded and stored in a manner conducive to future retrieval, review, analysis, modification, and possible re-use. The method and apparatus of the present invention uses a chained integration process (CIP), which treats a combination of information handling system hardware and a software delivery stack, including BIOS, device drivers, firmware, and other software components, as input. The individual components of the software stack are sequentially combined with various operating systems during the installation process. A validation process is iteratively performed as each component is installed, with resultant configuration data, testing processes, and related validation results saved into a Record Storage System (RSS). A Remote Management Unit (RMU) provides manual or automatic override, and re-boot or restart, of a system that is operating in a hung state to return the system to a stable state.

### BACKGROUND OF THE INVENTION

1. Field of the Invention

The present invention relates in general to the field of information handling systems management and deployment, and more specifically, to installing and validating the proper functioning of operating system and device management software.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

CPU (central processing unit) processing speed continues to increase, but the time required to install an information handling system's operating system using current methods remains unchanged. The average time to install an operating system, along with its required and/or associated components, is between 20 and 30 minutes. The time it takes to complete a successful installation can increase dramatically as the information handling system platform becomes more complex, especially if there are many or highly specialized peripheral components. Regardless of how complex the information handling system may be, each installation is tedious when using manual processes. These manual installation processes also lack a means to iteratively validate the proper interoperability of each component as it is sequentially installed. Problems ranging from missing device drivers to operating system (OS) hanging prevent the practical use of current testing and validation solutions on target information handling systems that are under development.

Further, no record is automatically generated of each system's installed components, the order they were installed, or their associated configuration settings. Absence of such records limits the ability to reproduce a specific installation, either for analysis or replicating the installation on another system. These issues are particularly troublesome where developers and testers devote significant amounts of time to manual system loads, and reloads, instead of development and result analysis efforts.

An apparatus and method for the automated, sequential installation and validation of system software components, with their associated configuration settings, capable of being retrieved for later re-use, does not exist today.

### SUMMARY OF THE INVENTION

The method and apparatus of the present invention overcomes the shortcomings of prior art by automating the installation of a plurality of operating system and device management software combinations, with their respective and related configuration data, onto a plurality of information management system platform hardware. The present invention also provides for the automated and systemic validation of proper interoperability between all installed software components. Further, all related details of the integration, installation and validation processes, regardless of any encountered errors, are automatically recorded and stored in a manner conducive to future retrieval, review, analysis, modification, and possible re-use.

In particular, the method and apparatus of the present invention uses a chained integration process (CIP), which treats a combination of information handling system hardware and a software delivery stack, including BIOS, device drivers, firmware, and other software components, as input. The individual components of the software stack are sequentially combined with various operating systems during the installation process.

A validation process is iteratively performed as each component is installed, with resultant configuration data, testing processes, and related validation results saved into a Record Storage System (RSS). A Remote Management Unit (RMU) queries the RSS at scheduled intervals to check if the system is in a hung state. If the system is in a state that passes a predetermined time limit, the RMU will record a failed test and then reboot the system to test the next configuration.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a schematic diagram of a software installation system at an information handling system manufacturing site.

FIG. 2 is a generalized illustration of an information handling system, such as the target information handling system 120 illustrated in FIG. 1.

FIG. 3 is a general illustration of a system for using a chained integration process (CIP) 304 for the automated, sequential installation and validation of information handling operating system (OS), and system software components with their associated configuration settings, capable of being retrieved for later re-use.

FIG. 4a is a flowchart illustration of the chained integration process sequence for implementation of the method and apparatus of the invention.

FIG. 4b is a flowchart illustration providing more detail of the chained integration process sequence when a RAID (redundant array of independent disks) mass storage array is integrated into the target information handling system.

FIG. 5 depicts a state diagram illustration for implementing the method and apparatus of the present invention, which is state-based.

### DETAILED DESCRIPTION

Although the present invention has been described in detail, it should be understood that various changes, substitutions and alterations can be made hereto without departing from the spirit and scope of the invention as defined by the appended claims.

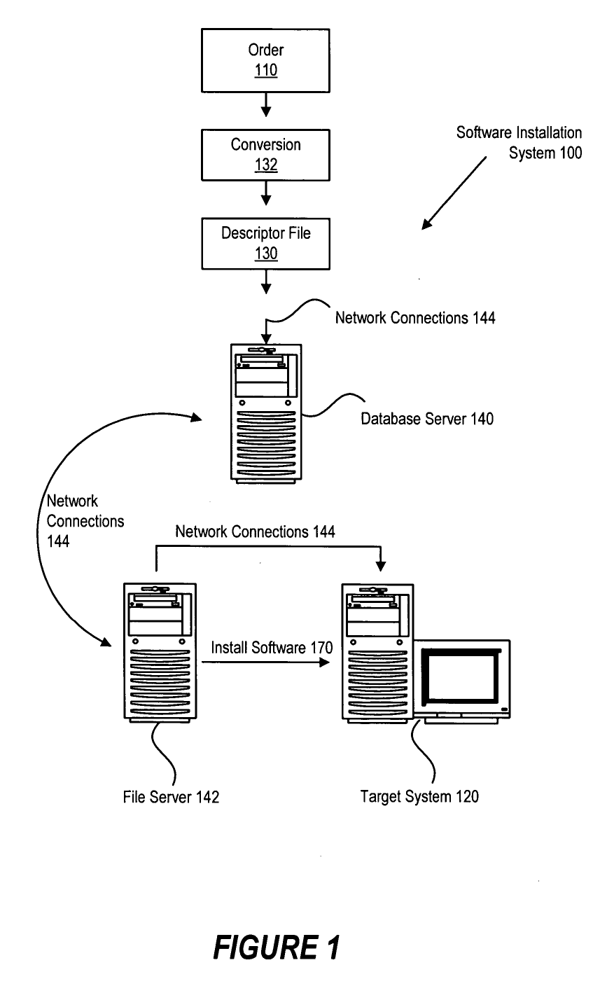

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before the target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling systems 120, which components are defined by the order 110. In an embodiment of the present invention, the component descriptors are included in a descriptor file called a system descriptor record, which is a computer readable file containing a list of components, both hardware and software, to be installed onto target information handling system 120. Having read the plurality of component descriptors, database server 140 provides a plurality of software components corresponding to the component descriptors of file server 142 over network connection 144. Network connection 144 may be any network connection well-known in the art, such as a local area network, an intranet or the Internet. The information contained in database server 140 is often updated such that the database contains a new factory build environment. The software is then installed on the target information handling system 120. Upon completion, the information handling system 120 will have a predetermined set of software, including a predetermined set of drivers corresponding to the specific configuration of the information handling system 120.

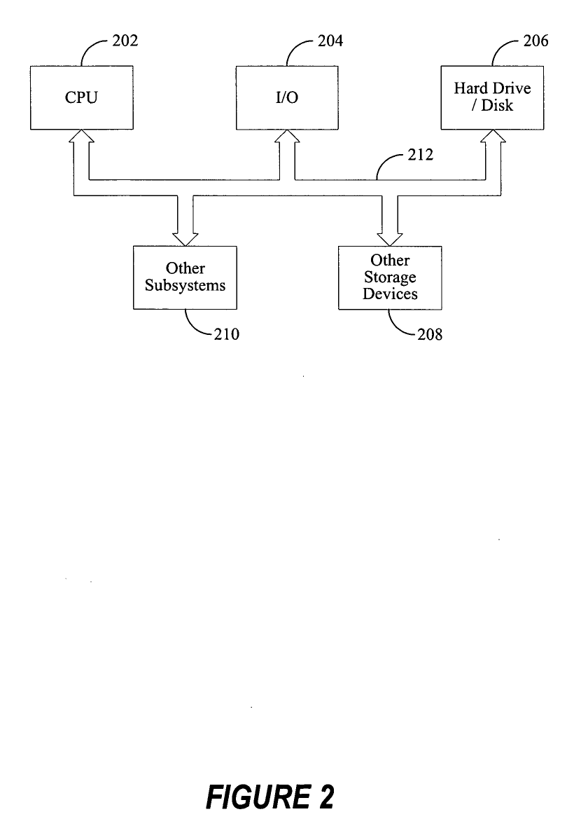

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206 and other storage devices 208, such as a floppy disk and drive and other memory devices, and various other subsystems 210, all interconnected via one or more buses 212. The software that is installed according to the versioning methodology is installed onto hard disk drive 206. Alternatively, the software may be installed onto any appropriate non-volatile memory. The non-volatile memory may also store the information relating to which factory build environment was used to install the software.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

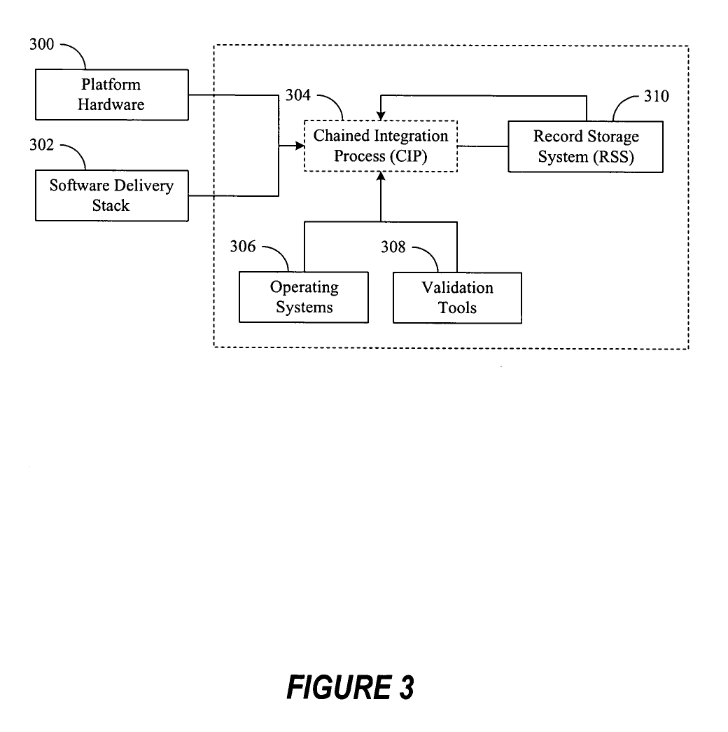

FIG. 3 is a general illustration of a system for using a chained integration process (CIP) 304 for the automated, sequential integration, installation and validation of information handling operating system (OS), and system software components with their associated configuration settings, capable of being retrieved for later re-use. In the system illustrated in FIG. 3, an information handling system platform hardware 300, comprised of a plurality of computing hardware components, is associated with a software delivery stack 302, comprised of system software including BIOS, device drivers, firmware, and other software components, which are treated as inputs to the CIP 304. An operating system (OS) 306 is installed by the CIP 304 onto the platform hardware 300 along with a set of corresponding validation tools 308. As each component of the software delivery stack 302 is sequentially installed, tests are run by the validation tools 308 for proper operation and interoperability. The sequence of installation, along with the results of the validation tests, as well as a time-stamped history of any manual or automatic intervening steps, are stored in the Record Storage System (RSS) 310.

In one embodiment of the invention, the platform hardware 300 is physically and locally connected to the CIP system 304. In another embodiment of the invention, the platform hardware 300 is remotely connected to the CIP system 304 through a network. Those skilled in the art will appreciate that the network connection can be accomplished by any method (e.g., dial-up, broadband, wireless, etc.) capable of establishing and sustaining data communications. In another embodiment of the invention, the platform hardware 300 may be located in a first physical location, and the CIP system 304 may be located in a second physical location, and the software delivery stack 302 may be located on an information handling system in a third location, and the operating system 306 to be installed on the platform hardware 300 may be located on an information handling system in a fourth location, and the validation tools 308 may be located on an information handling system at a fifth location, and the RSS 310 may be located on an information handling system at a sixth location, with all connected through a suitable data communications network. Those skilled in the art will recognize that each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

The present invention, as discussed in greater detail below, provides a method and apparatus that overcomes the shortcomings of prior art by automating the installation of a plurality of operating system and system software combinations, with their respective and related configuration data, onto a plurality of information management system platform hardware. The present invention also provides for the automated and systemic validation of proper interoperability between all installed platform hardware and software components. Further, all related details of the installation and validation process are automatically recorded and stored by the present invention in a manner conducive to future retrieval, review, analysis, modification, and possible re-use.

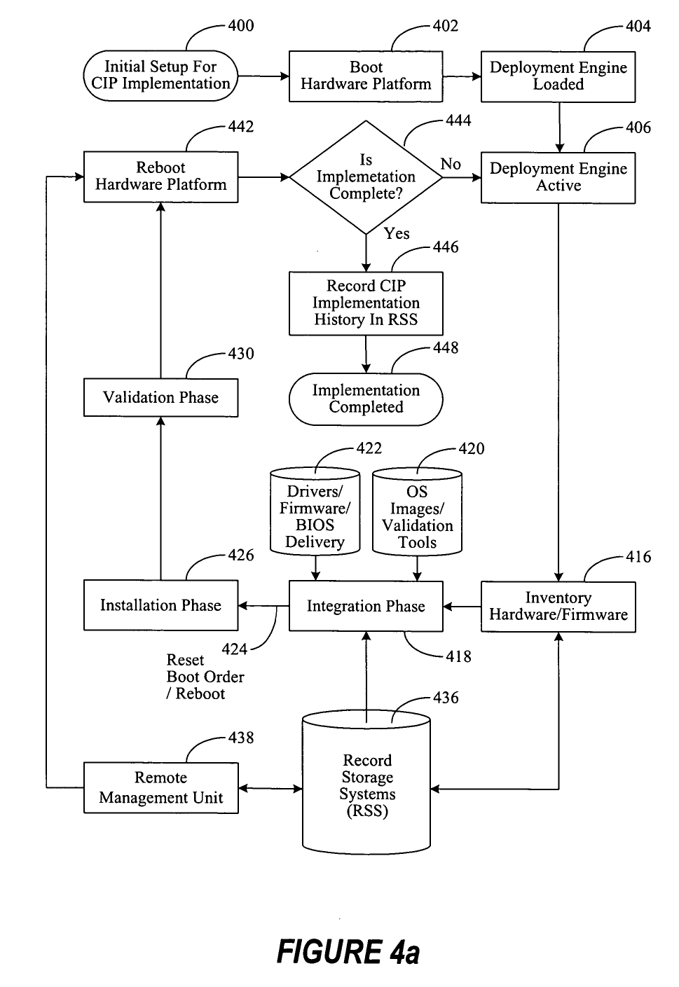

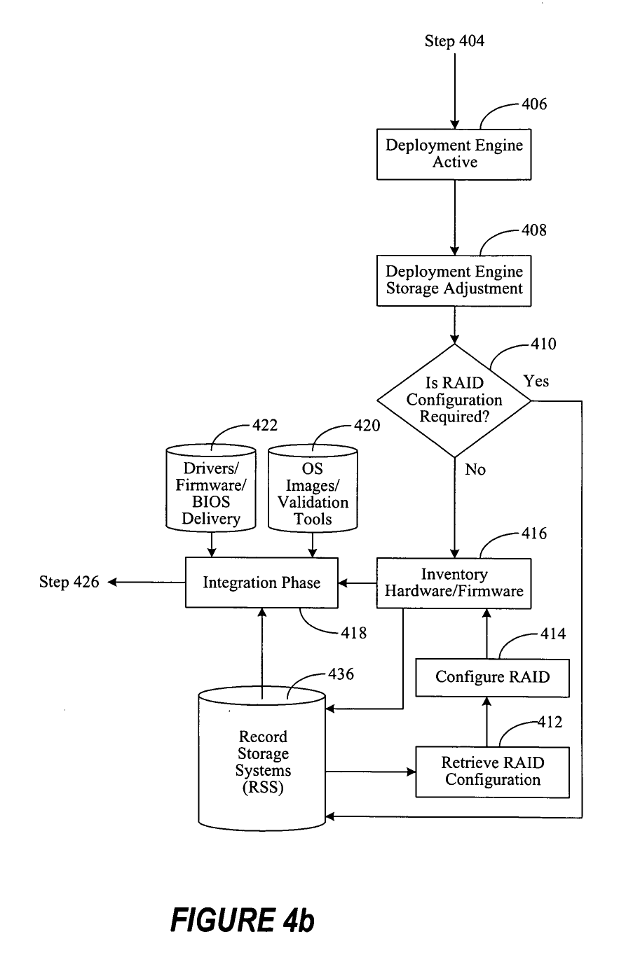

FIG. 4a is a flowchart illustration of the chained integration process sequence for implementation of the method and apparatus of the invention. In step 400, instructions for the initial setup and implementation are composed. Those skilled in the art will recognize that such instructions may be a composite of one or more individual instructions that can be combined in a variety of ways to accomplish different goals and/or to accommodate specific implementation requirements. Furthermore, the instructions may be manually entered through a human interface, or may be entered automatically by one or more information handling systems, directly connected to the CIP system or remotely connecting through a network, with some instructions possibly invoking other individual or composite instructions as required.

In step 402, the implementation process is begun, using instructions from the initial setup in step 400, by booting the platform hardware. In step 404, a deployment engine is loaded onto the platform hardware. In step 406, the deployment engine is activated for use by the CIP system.

In step 416, a platform hardware inventory is performed, recording the BIOS version, device lists, firmware versions, and other related system information, with the results stored in the RSS 436.

In step 418, the integration phase is initiated by the deployment engine 406 copying the operating system image and validation tools 420, along with the software delivery stack which includes device drivers, firmware and BIOS information, and other system software components 422 to the platform hardware.

In one embodiment of the invention, the boot order of the platform hardware is changed to boot-from-local-disk and the platform hardware is rebooted in step 424.

In step 426, the installation phase is initiated by the operating system, which installs device drivers, firmware and BIOS information, and other system software components 422, as supplied by the deployment engine 406. During the installation phase, in step 438, the remote management unit (RMU) checks the RSS at scheduled intervals to see if the system is in a state that has exceeded its predetermined time limit. If it has, the system is considered to be in a hung state, a failed result is written to the RSS, and the system is rebooted by the RMU in step 442. Furthermore, the RSS records when the RMU reboots the system in step 442, along with a history of all related system information up to that point.

In step 430, the validation phase is initiated and its status is monitored by a persistent program or software agent, described in more detail hereinbelow. During the validation phase, in step 438, the remote management unit (RMU) checks the RSS at scheduled intervals to see if the system is in a state that has exceeded its predetermined time limit. If it has, the system is considered to be in a hung state, a failed result is written to the RSS, and the system is rebooted by the RMU in step 442. Furthermore, the RSS records when the RMU reboots the system in step 442, along with a history of all related system information up to that point.

In step 444, the status of the implementation is monitored by a persistent program or software agent, described in more detail hereinbelow. If, in step 444, the status of the implementation is incomplete, the CIP system instructs the deployment engine 406 to continue the implementation, repeating the steps described hereinabove. In one embodiment of the invention, manual intervention through the RMU 438, may be required to restart the implementation, repeating the steps described hereinabove. In another embodiment of the invention, manual or automatic intervention through the RMU 438 may be required to provide alternative, or necessary instructions and/or system software components to the deployment engine 406 before it repeats the steps hereinabove. Those of skill in the art will appreciate that many different combinations of manual and automatic processes, together with many different combinations of system software components can be used, and many other embodiments of the invention are possible.

If, in step 444, the implementation is completed, step 446 records the implementation history, and all related system information at the point the implementation was completed, in the RSS. In step 448, the implementation is signified as complete and the CIP system is halted. In one embodiment of the invention, when implementation is completed in step 448, the CIP system automatically prepares itself for one or more additional implementations on other platform hardware, each of which is manually initiated. In another embodiment of the invention, the CIP system sequentially automates the implementation process on a plurality of platform hardware.

FIG. 4b is a flowchart illustration providing more detail of the chained integration process sequence when a RAID (redundant array of independent disks) mass storage array is integrated into the target information handling system. In step 404, a deployment engine has been loaded onto the platform hardware as illustrated in FIG. 4a and described in more detail hereinabove. In step 406, the deployment engine is activated for use by the CIP system. In step 408, the deployment engine 406 loads a predetermined set of mass storage device drivers onto the platform hardware.

In one embodiment of the invention, illustrated in step 410, the deployment engine 406 checks the Record Storage Systems (RSS) 434 to see if a requirement for a RAID (redundant array of independent disks) configuration is required. If a RAID configuration is not required, a platform hardware inventory is performed in step 416, recording the BIOS version, device lists, firmware versions, and other related system information, with the results stored in the RSS 436.

In another embodiment of the invention illustrated in step 410, the deployment engine 406 checks the RSS 436 to see if a requirement for a RAID configuration is required. If a RAID configuration is required, the appropriate RAID configuration is retrieved in step 412 from the RSS 436, and the platform hardware is configured appropriately to support the RAID configuration in step 414. In step 416, a platform hardware inventory is performed, recording the BIOS version, device lists, firmware versions, and other related system information, including the RAID configuration, with the results stored in the RSS 436.

In step 418, the integration phase is initiated by the deployment engine 406 copying the operating system image and validation tools 420, along with the software delivery stack which includes device drivers, firmware and BIOS information, and other system software components 422 to the platform hardware. In step 426, the installation phase is initiated as illustrated in FIG. 4a.

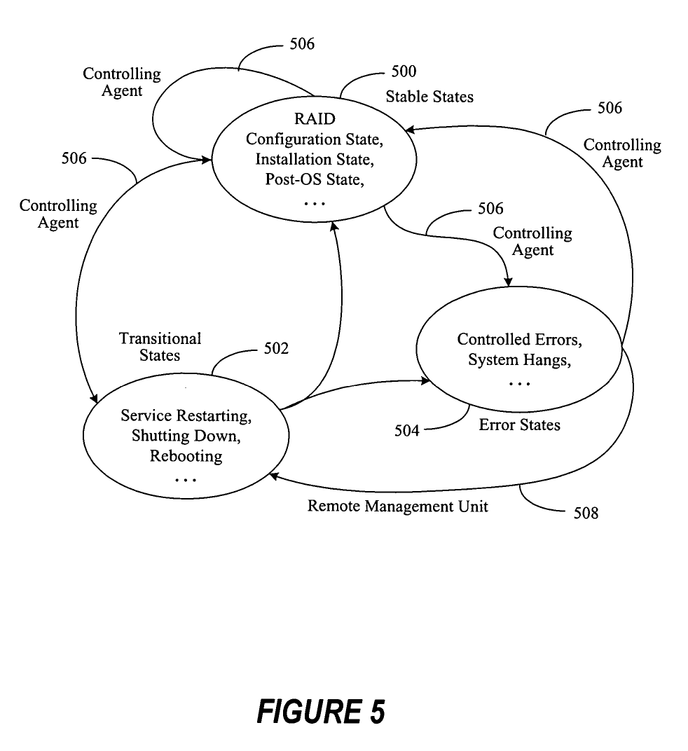

FIG. 5 is a state diagram illustration for implementing the method and apparatus of the present invention, which is state-based. In general, the chained integration process (CIP) system resides in one of three states. A stable state 500 is a system state such as configuring a redundant array of independent disk (RAID) storage devices, an integration state, or a post-installed-operating system state that is controlled by a persistent program or software agent described in more detail hereinbelow. A transitional state 502 is a state where the system is transforming itself to another state without intervention from an external program, such as the platform hardware rebooting, services starting, or the platform hardware shutting down. An error state 504, is entered into when the system encounters an error and either enters into a controlled error state that can be recovered by the controlling program or enters into a hanging state requiring intervention by the CIP system's remote management unit (RMU). Those skilled in the art will understand that additional states could be defined as an expansion to, or extension of, the states defined herein, as well as sub-state classifications which may be defined in specific embodiments of the present invention.

A stable state 500 and controlled error state 504 has one or more persistent programs, or software agents 506, that can be run when the CIP system reaches its associated state. Among other things, the persistent program or software agent 506 has the ability to collect platform hardware and system inventory information as well as associated configuration settings. Furthermore, the persistent program or software agent 506 can also communicate with a database or other storage apparatus embodied within the record storage systems (RSS) to retrieve, store, update, alter, delete, and otherwise manage information generated by the CIP system that is stored in the RSS. One or more persistent programs or software agents 506 have the ability to independently and/or simultaneously access a common RSS or a distributed RSS. Once the persistent program or software agent 506 accesses an RSS, it is capable of executing programs, performing tasks, running processes, or invoking other persistent programs or software agents as instructed by the RSS. As these actions take place, the persistent program or software agent 506 has the innate ability to provide a synchronized timestamp to every operation it performs within each state. Moreover, the persistent program or software agent 506 has the ability to traverse to another state, for instance when a task is completed, or when a time allocation for a task to be performed has timed-out.

A hanging state, which is one instance of an error state 504, can be interceded through the manual or automated use of the remote management unit (RMU) 508. The RMU 508 accesses the RSS and retrieves information required to return the system to another, non-hanging state.

Use of the invention will insure, at a minimum, that a developer or other technician can automate the set-up of platform hardware by choosing an appropriated software delivery stack and initiate the CIP system, allowing more time to be made available for core development or testing responsibilities. Further, the invention automatically generates platform hardware test records that are comprehensive, accurate, and free of manual errors. These records provide the basis for a wide variety of analytical purposes including, but not limited to, baseline comparison, operability assessment, conflict resolution, and data mining. Furthermore, the records produced by the system provide a means of easily and sequentially replicating similar implementations on a plurality of platform hardware.

What is claimed is:

1. A system for software integration and validation, comprising:
a chained integration processor;
a hardware platform comprising a plurality of operating components corresponding to an information handling system;
a software delivery stack operable to provide a plurality of software packages for compatibility testing with said hardware platform;
a plurality of operating systems; and
a plurality of validation tools;
wherein said chained integration processor is operable to use said validation tools to verify compatibility of said software packages with said hardware platform for said plurality of operating systems.

2. The system of claim 1, wherein said compatibility of said software packages with said hardware platform for said plurality of operating systems is verified by sequentially combining said software packages with individual operating systems in said plurality of operating systems.

3. The system of claim 1, further comprising a record storage system operable to automatically store configuration data and validation results corresponding to compatibility of said software packages with said hardware platform for said plurality of operating systems.

4. The system of claim 3, wherein verification of compatibility is state-based.

5. The system of claim 4, wherein said verification of compatibility results in a stable state.

6. The system of claim 4, wherein said verification of compatibility results in a transitional state.

7. The system of claim 4, wherein said verification of compatibility results in an error state.

8. The system of claim 7, wherein said chained integration processor further comprises a remote management unit operable to recover operation of said hardware platform from an error state.

9. The system of claim 4, wherein each of said states has an associated persistent program operable to collect information relating to system configuration.

10. The system of claim 1, wherein said persistent program is operable to communicate with said record storage unit and to store information therein corresponding to the compatibility of said software packages with said hardware platform for said plurality of operating systems.

11. A method for software integration and validation, comprising:
operably coupling a hardware platform and a software delivery stack, comprising a plurality of software packages, to a chained integration processor;
running a plurality of operating systems on said hardware platform in conjunction with said plurality of software packages; and
using said chained integration processor to implement a plurality of validation tools to verify compatibility of said software packages with said hardware platform for said plurality of operating systems.

12. The method of claim 11, wherein said compatibility of said software packages with said hardware platform for said plurality of operating systems is verified by sequentially combining said software packages with individual operating systems in said plurality of operating systems.

13. The method of claim 11, further comprising a record storage system operable to automatically store configuration data and validation results corresponding to compatibility of said software packages with said hardware platform for said plurality of operating systems.

14. The method of claim 13, wherein verification of compatibility is state-based.

15. The method of claim 14, wherein said verification of compatibility results in a stable state.

16. The method of claim 14, wherein said verification of compatibility results in a transitional state.

17. The method of claim 14, wherein said verification of compatibility results in an error state.

18. The method of claim 17, wherein said chained integration processor further comprises a remote management unit operable to recover operation of said hardware platform from an error state.

19. The method of claim 14, wherein each of said states has an associated persistent program operable to collect information relating to system configuration.

20. The method of claim 11, wherein said persistent program is operable to communicate with said record storage unit and to store information therein corresponding to the compatibility of said software packages with said hardware platform for said plurality of operating systems.
